(19) United States
(12) Patent Application Publication
(10) Pub. No.: US 2002/0127530 A1
(43) Pub. Date: Sep. 12, 2002

(54) System and method for tracking and displaying a user's progress in a distance learning environment

(76) Inventor: Mark A. Weakly, Lincoln, NE (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/800,131

(22) Filed: Mar. 6, 2001

(51) Int. Cl. G09B 3/00

(52) U.S. Cl. 434/350

(57) ABSTRACT

A system and method for tracking and displaying a user's progress in a distance learning program such that the user and a teacher can independently observe the user's progress through the program. A tracker software program tracks the user's progress through the program, creates a history file of the user's progress, stores the history file on a remote server for independent access by the user and a teacher, and displays the user's progress to the user and/or teacher via a site map.

### BACKGROUND OF THE INVENTION

The present invention relates generally to distance learning programs and, more particularly, to a system and method for tracking a student's progress through a distance learning program such that the student's progress may be observed independently by the student and a teacher.

Distance learning programs are known in the prior art. Typically, in a distance learning program, educational information is supplied to students via CD-ROM, printed materials, the Internet, and/or a combination thereof. There are no live lectures. Rather, students perform independent study to learn the educational information supplied. There is a desire for students to be able to observe the structure of a distance learning program, navigate through the program, and track and observe their progress through the program via a processor. There is also a desire for teachers to be able to independently track and observe the students' progress through a program.

Systems and methods that track a user's progress through a web site are known in the prior art. Nothing in the prior art, however, suggests the tracking of a student's progress through a distance learning program such that the student and a teacher can independently track and observe the student's progress.

As recognized by the inventor hereof, what is needed is a system and method that monitors and tracks a student's progress through a distance learning program such that a student and teacher can independently track and observe the student's progress.

### SUMMARY OF THE INVENTION

In order to solve these needs in the art, the inventor hereof has designed and developed a system and method for tracking and displaying a student's progress in a distance learning program such that the student and a teacher can independently observe the student's progress through the program. In general, a tracker software program tracks the student's progress through the program, creates a history file of the student's progress, stores the history file on a remote server for independent access by the student and a teacher, and displays the student's progress to the student and/or teacher via a site map.

In accordance with one aspect of the present invention, a teaching system for use by a user with a user processor for teaching the user information includes a distance learning program having a URL structure of linked pages accessible by the user via the user processor. The linked pages include the information to be taught to the user. A tracker software program tracks the user's progress through the linked pages of the distance learning program and creates a history file of pages visited by the user. The history file is remotely stored on a server for independent access by the user via the user processor and a by teacher via a teacher processor.

In accordance with another aspect of the present invention, a method for tracking and displaying a user's progress through a distance learning program having a URL structure of linked pages accessible by a user with a processor and including information to be taught to the user, and a site map for graphically displaying the URL structure of linked pages to the user via the user processor includes tracking the user's progress through the linked pages of the distance learning program and creating a history file of pages visited by the user. The history file is remotely stored on a server for independent access by the user via the user processor and a teacher via a teacher processor. The method also includes receiving a request from the user for a site map of the distance learning program, and displaying the user's progress based on the history file to the user via the site map, the site map being displayed to the user via the user processor.

Other features and advantages of the present invention will be in part apparent and in part pointed out hereinafter.

### BRIEF DESCRIPTION OF THE DRAWINGS

FIG. 1 is a block diagram of one preferred embodiment of the system of the invention illustrating the main components of the system.

FIG. 2 is a site map of a distance learning program course according to the invention.

FIG. 3 is a portion of a site map of a distance learning program course illustrating a course beginning page and the unit level pages linked to the course beginning page according to the invention.

FIG. 4 is a portion of a site map of a distance learning program course illustrating a selected unit level page and the section level pages linked to the selected unit level page according to the invention.

FIG. 5 is a partial view of a site map of a distance learning program course illustrating a selected section level page and the sub-section level pages linked to the selected section level page according to the invention.

FIG. 6 is a partial view of a site map of a distance learning program course illustrating the color coding of the site map according to the invention.

FIG. 7 is a flow chart illustrating the operation of the tracker software program in a distance learning program according to the invention.

### DETAILED DESCRIPTION OF PREFERRED EMBODIMENTS

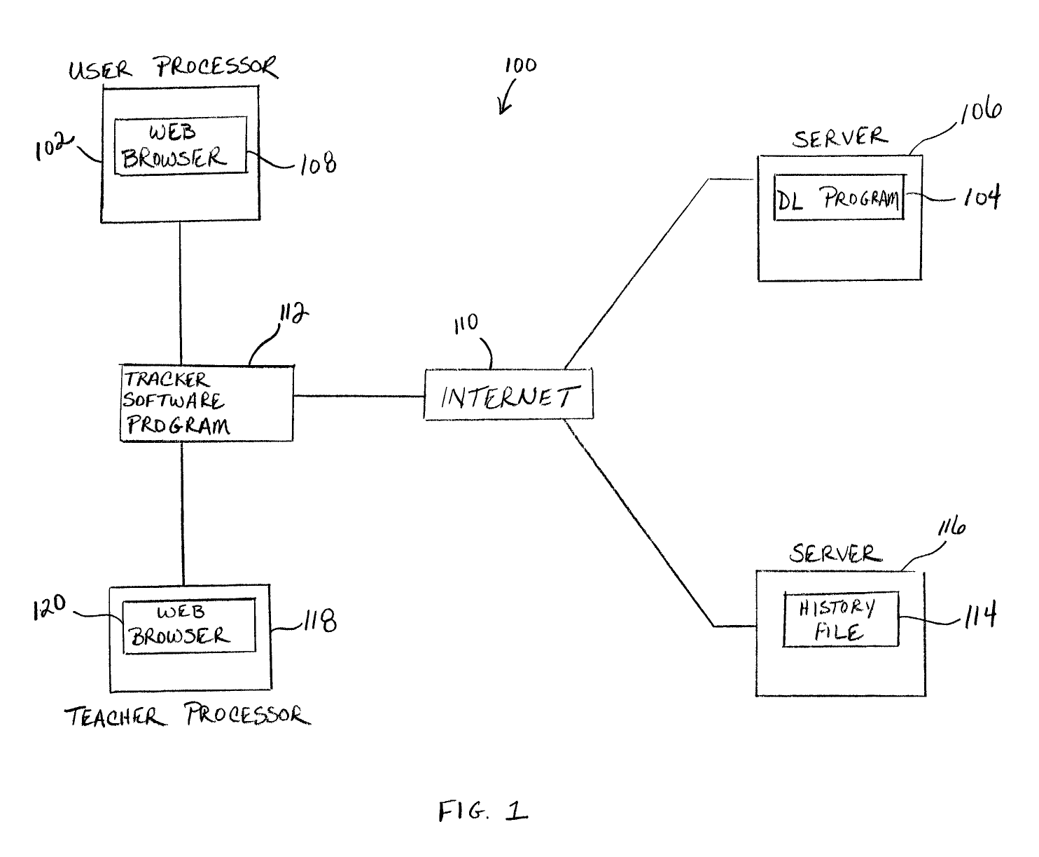

Referring now to the drawings, a teaching system according to one preferred embodiment of the present invention is shown in FIG. 1 and is designated generally by reference character 100. The teaching system 100 is for use by a user, such as a student, via a processor 102 for teaching the user information.

A distance learning (DL) program 104 has a URL (uniform resource locator) structure of linked pages (not shown). Each linked page has a unique address, or URL, which specifies the location of each page in the DL program 104. The linked pages include the information to be taught to the user. In the distance learning environment, the information to be taught to the user typically includes computerized instruction organized into distance learning courses which contain educational material such as text, graphics, audio, and video, related to various subjects. The URL structure of the DL program 104 is independent of the file system directory structure of the DL program 104. The URL structure does not have any platform specific bounds and does not dictate that any of the linked pages are on the same server.

The DL program 104 also has a site map (not shown) that graphically depicts the URL structure of the DL program 104. The site map is displayed to the user via the user processor 102 and facilitates navigation of the DL program 104. Typically, each distance learning course of the DL program 104 will contain its own site map. Each course site map depicts the course structure as designed by the course designer. The site map is created using a graphical tool designed specifically for this task. In this way, the site map can be customized by the course designer. Preferably, each course site map does not depict all URL accessible web content of the course. Rather, it is preferred that each course site map depict only the “main” content frame of the course as determined by the course designer. Site maps that depict the URL structure of a web site are known in the prior art. Examples of such site maps are illustrated and/or described in U.S. Pat. No. 5,985,008 (Pogrebisky, et al.), U.S. Pat. No. 5,870,559 (Leshem, et al.), and U.S. Pat. No. 6,038,610 (Belfiore, et al.), each of which is incorporated herein by reference. A conventional web crawler program may be used with the invention to initialize the site map data. Examples of conventional web crawlers are described in U.S. Pat. No. 5,985,008 (Pogrebisky, et al.) and U.S. Pat. No. 5,870,559 (Leshem, et al.), each of which is incorporated herein by reference.

The DL program 104 is stored on a server 106 remote from the user processor 102 and accessible by a user via the user processor 102. The user processor 102 can be part of any device which is capable of transmitting and receiving data, including, but not limited to, personal computers, laptop computers, handheld personal digital assistants, and cellular telephones. The user processor 102 includes a web browser 108 responsive to user input, which locates specific pages associated with the DL program 104. The web browser 108 is a typical software program providing the user with access to the DL program 104 via a network. The network may be any medium for transmitting and receiving data between two processors. In this embodiment, the network is the Internet 110. Those skilled in the art will recognize that the invention does not require any particular configuration of either the network or the processors and servers connected thereto.

The system 100 further includes a tracker software program 112 comprised of a Java applet for tracking and storing a user's progress through the linked pages of the DL program 104. The tracker software program 112 may be located on the user processor 102 or may be remote from the user processor 102 as shown in FIG. 1. In addition, although the tracker software program 112 is HTML frame coherent, it is not multiple HTML frame synchronous. Therefore the tracker software program 112 according to the invention does not evaluate HTML frame contents other than that which the tracker software program 112 has been configured to target.

As a user progresses through the DL program 104, the tracker software program 112 tracks the linked pages the user has visited. The tracker software program 112 tracks the user's study path to the individual page level. The tracker software program 112 creates a history file 114 of the pages visited by the user by storing the URL for each page visited by the user in the history file 114. The history file 114 is stored remote from the user processor on a server 116 such as a SQL or database server for each user of the DL program. The history file may be stored on the same server(s) 106 as the DL program 104 or it may be stored on another server 116 as shown in FIG. 1.

The user may monitor his or her progress through the DL program 104 by accessing the history file 114 via the user processor 102. In addition, a teacher may independently monitor the user's progress through the DL program 104 by accessing the history file 114 via a processor 118 independent from the user processor. The teacher's processor 118 includes a web browser 120 that provides the teacher with access to the history file 114 and DL program 104 via a network, such as the Internet 110.

According to one preferred embodiment of the invention, the user's progress through the DL program 104 based on the respective history file 114 is displayed to the user and/or a teacher via a site map. As described above, each distance learning course of the DL program has its own site map depicting the URL structure of the course. The user's progress through a particular course is displayed to the user and/or teacher on the respective course site map.

The tracker software program can exist independently, without the site map. The site map, however, relies on the tracker software program to manage data and communicate that data to the SQL server via Java servlets. When a user visits a page, that page only is noted in the file history record for that user. All other media and files loaded as a consequence of loading that page are not processed. Therefore the site map is not a complete site map of all URL accessible web content. Rather, the site map depicts the URL structure of the “main” content frame of the course. The pages that show up in the site map are determined by the course designer.

When a user opens the site map, the “common” site map data that resides on the SQL server is initialized. The data for the site map view was created by the course designer using a site map entry utility. When the user progresses through the course, a color-coded trail marks his or her progress on the site map whether the user navigates through the course using the web browser or site map. Thus, by accessing the site map of a particular course, the user and/or teacher may observe the user's progress through the respective course.

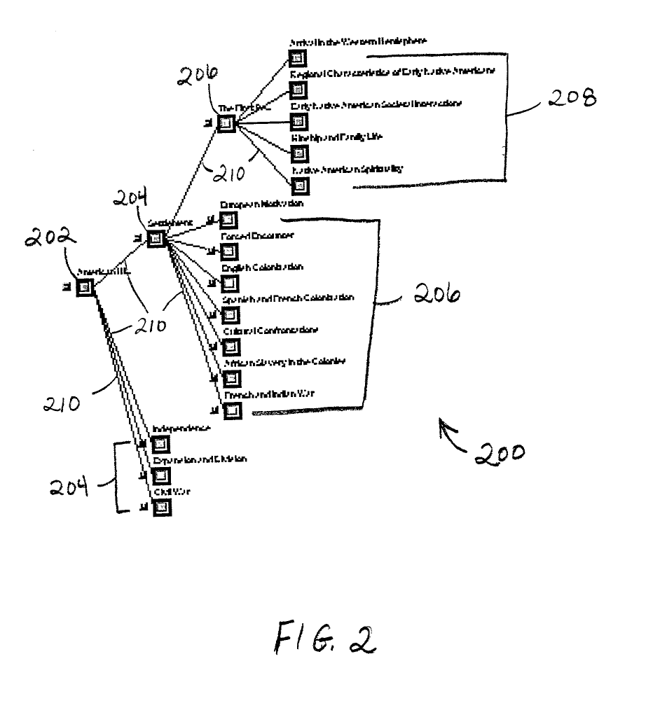

A partial view of a site map of a DL program course used to display a user's progress through the course according to the present invention is illustrated at FIG. 2 and designated generally by reference character 200. The site map may be displayed to a user and/or teacher in a graphical tree view, as shown in FIG. 2, or in a list view (not shown) in which the URL addresses for the linked pages are displayed in outline form. As discussed above, a DL program is typically organized into courses relating to various subjects. The courses are structured in units, sections, sub-sections, etc. A site map according to the present invention may represent a DL program 104, or it may represent one particular course in a DL program. The site map 200 illustrated in FIG. 2 represents the URL structure for one particular course in a DL program. The URL structure of a DL program is targeted, or linked, to a beginning page (not shown) of the DL program. Similarly, the URL structure of each DL program course is targeted, or linked, to a course beginning page 202 for the respective course.

As seen in FIG. 2, the course includes a course beginning page 202, unit level pages 204, section level pages 206, and sub-section level pages 208. Those skilled in the art will recognize that the invention does not require any particular configuration of pages beyond the course beginning page 202. The pages in a DL program and/or DL program course are linked and each have a unique address, or URL. Each page contains image maps to provide the URL links. The lines 210 which interconnect the pages represent links between the URLs in a particular course. Each URL is targeted to the course beginning page 202 via the links 210. As shown in FIG. 2, the course includes four unit level pages 204 which are each linked to the course beginning page 202. Each unit level page 204 represents a “unit” of the course which may teach a separate topic relating to the course. For example, if the topic of the course is “mathematics,” the four units may relate to instruction on fractions, percentages, integers and decimals. Each unit level page 204 is linked to the first page of each section, such as section pages 206, relating to the unit if applicable. Each section level page 206 is further linked to the first page of each respective sub-section, such as sub-section pages 208, if applicable, and so forth. There is continuity between the course beginning page 202 and each subsequent unit level page 204, section level page 206 and sub-section page 208 of the course via the links 210.

Users can access the site map at any time to see the structure of the program and/or to see their progress through the program. In addition, a user may navigate through a DL program 104 or DL program course via the site map by selecting a page displayed to the user on the site map. The selected page is then displayed to the user via the user processor 102. The site map therefore provides a convenient method for the user to locate a particular page in the course.

The tracker software program 112 provides a convenient method for the user to return to the last page of the DL program visited by the user during a previous DL session. Since the tracker software program 112 tracks the user's study path to the individual page level, the system allows the user to return to the exact page they left when exiting and re-entering the course. This may be accomplished via the user processor 102 by selecting a button or menu selection labeled “Go to where I left off.” The URL for the last page visited by the user during a previous DL session is stored in a table other than the file history 114. Therefore, the “Go to where I left off” feature allows the user to return to any page of the course that is targeted to the “main” frame.

A user can create messages or notes for himself or herself and attach such messages and/or notes to any object page on the site map selected by the user. It is possible that hot links to Internet URLs may be included within the messages and notes. The notes are stored on the SQL server with the history file for each user. The messages and notes are displayed to the user and/or teacher on the site map.

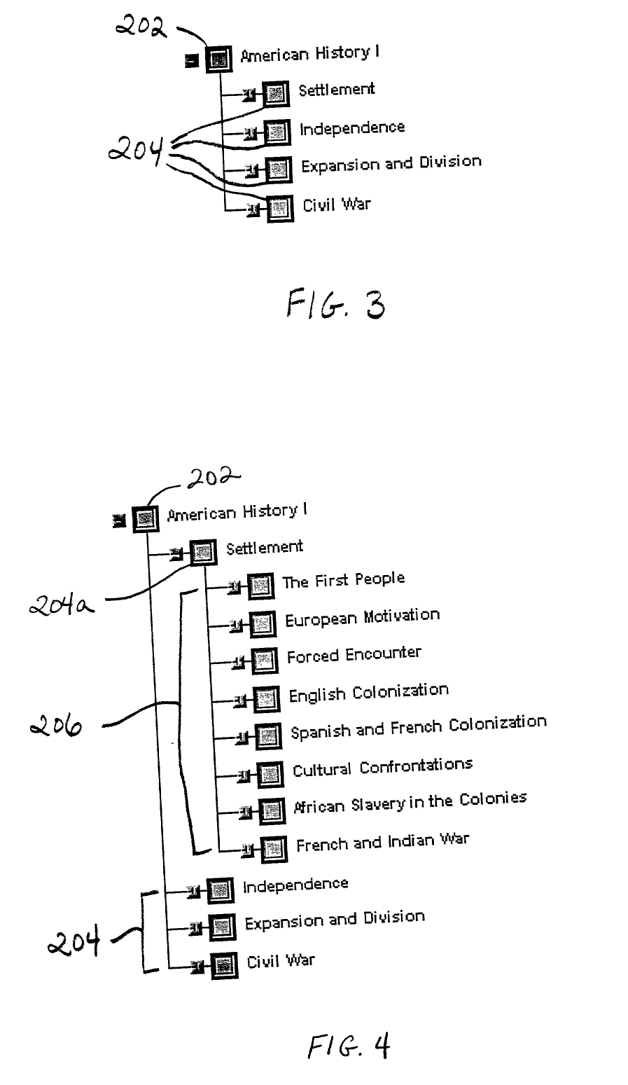

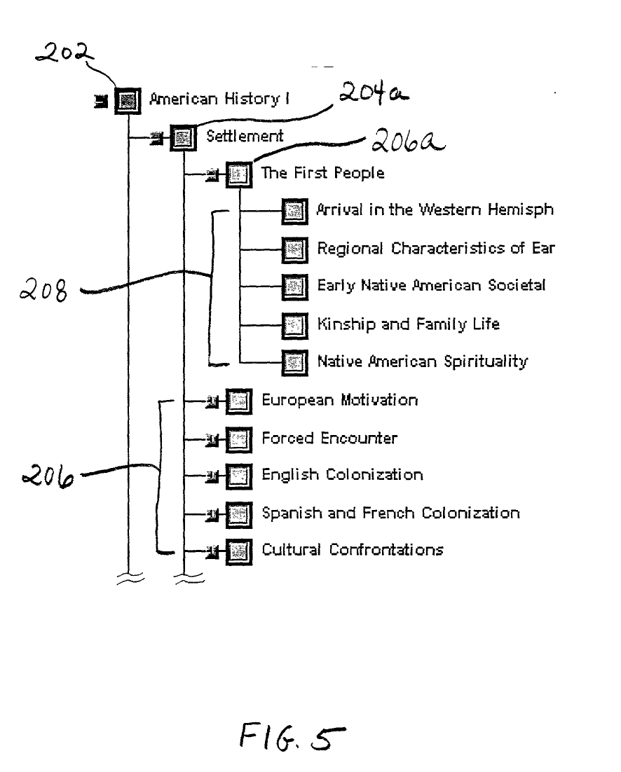

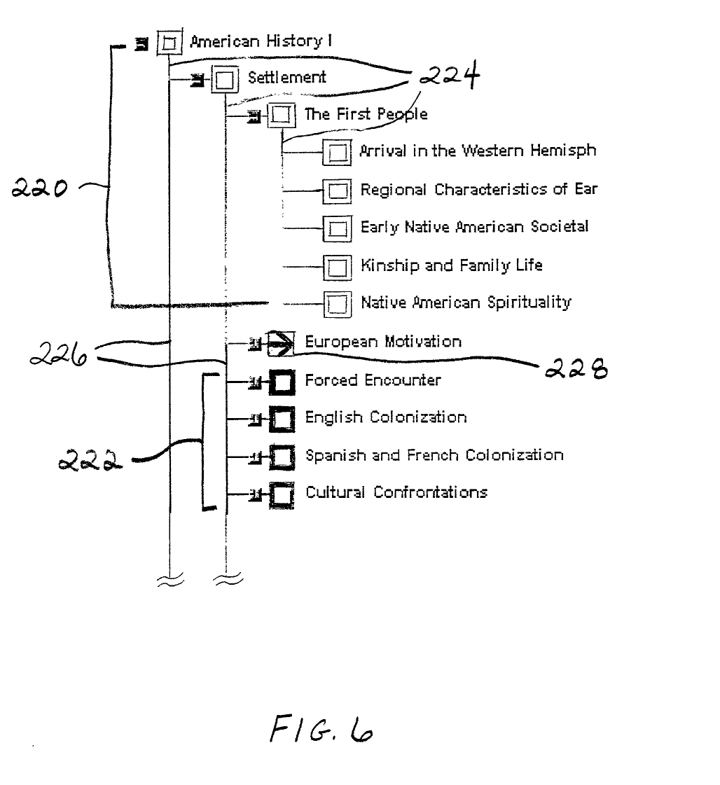

At the request of a user, the site map such as the site map shown in FIG. 2 is displayed to the user via the user processor 102. As discussed above, the site map may be configured to display the URL structure of a complete DL program or a complete DL program course. In addition, the site map may be configured to display only a portion of the URL structure of a complete DL program or a complete DL program course. This is done to lower the total number of pages displayed to the user to an amount desirable for best understanding of the URL structure. For example, the site map for a DL program course may be configured such that only the URL structure from the course beginning page 202 to the unit level of pages 204 is displayed to the user. An example of such a site map is shown in FIG. 3. Similarly, the site map may be configured such that when a particular unit level page 204a is selected by the user, the URL structure from the selected unit level page 204a to the section level pages 206 linked to that unit level page 204a is displayed as shown in FIG. 4. The site map in FIG. 5 shows the URL structure from a selected unit level page 204a, a selected section level page 206a, and the sub-section level pages 208 linked to the selected section level page 206a. Those skilled in the art will recognize that numerous configurations of the site map may be displayed to the user and that the invention does not require any particular configuration of the site map.

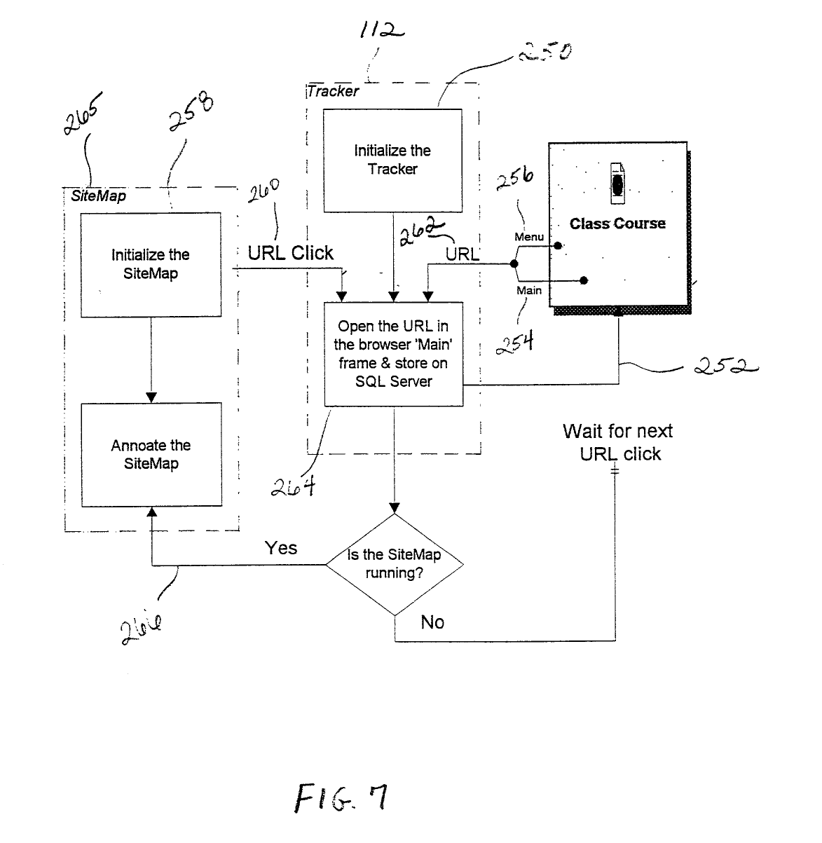

The site map according to the present invention is preferably color coded to indicate the pages visited by the user. For example, the pages previously visited by the user may appear in yellow and the page currently visited by the user may appear in red and may “blink.” The pages yet to be visited by the user may appear in a third color, such as blue. The lines, or “links,” depicted on the site map between the pages may also be color coded to further emphasize the user's “path” through the course. FIG. 6 illustrates an example of the color coding. In this example, an example of the pages previously visited by the user 220 appear in one color (such as yellow) and the pages yet to be visited by the user 222 appear in a second color (such as the color blue). The lines or links 224 between the pages previously visited by the user also appear in the same color as the pages previously visited (i.e., yellow). The lines or links 226 between the pages yet to be visited appear in the same color as those pages yet to be visited (i.e., blue). The page currently visited by the user, such as unit page 228, “European Motivation,” may appear in a third color, such as red, and may “blink.” If the page currently visited by the user 228 resides deeper in the URL structure than what is currently in view, the closest parent to the page currently visited, that is in view, will be annotated with an arrow, as shown in FIG. 6. In this way the user can know where in the URL structure they currently reside, even if the page they are currently at is not in view.

FIG. 7 illustrates the operation of the tracker software program (“tracker”) 112. The tracker applet is initialized 250 with data read from the SQL server via Java servlet. These data contain, among other things, the common course map data, user course map data, user session data, and user custom data. The user course map data contains the visitation and page notes information that is used to annotate the user's specific graphic view of the course. The tracker also receives configuration information from special applet parameter tags, some of which are initialized by states maintained within the browser's primary frameset and child frame objects.

Once initialized, the tracker applet loads 252 the “splash” and “splash menu” documents into the “main” 254 and “menu” 256 frames of the browser respectively. These frames share a child relationship with the primary frameset that is loaded into the browser when the course index page is opened. In the “menu” frame the “splash menu” contains two button links usually named “Orientation” and “Begin Course.” If the user has entered the course at least once previously, a third link “Go to where I left off” or “Last Session” will also be available.

After the user has clicked one of the first two or three buttons available in the “splash menu,” the “menu” frame document is replaced with a navigation menu including a toolbar. The toolbar contains a button link that launches the graphical “site map” applet (the button is named “Contents”).

When the “Contents” button link is clicked, the site map applet launches, reading the course map and user course map data via Java servlet. These are two of the same data sets read by the tracker during its initialization, however, the user course map data set will contain any updated data that might have been accumulated in the time between when the tracker initialized 250 and the site map initialization process 258.

Links clicked on in either the “main” 254 or “menu” 256 frame, or within the graphical site map window, will be routed 260, 262 to the tracker applet. The communication of the URL clicks made in either of the browser “main” 254 “menu” 256 frames are communicated to the applet using JavaScript. The tracker is responsible for keeping the information current in the user's data partition on the SQL server, and so will store 264 the state of the page being visited at the time when the page for the link clicked is loaded. If the tracker detects that the site map 265 has been launched, it will also route 266 the visitation information to the site map applet as well. This process takes place in a portion of the tracker functionality that is implemented in JavaScript, and is within a function called by the URL clicks from the “main” and “menu” frames. Also within this function is the conditional to communicate the URL information to the site map Java applet.

The flow of information is unidirectional and follows a single path. That is, if a link is clicked on within the “main” or “menu” frames or within the site map, the event is communicated to the tracker 112 JavaScript function, which communicates to the tracker Java applet (using JavaScript to Java communication), and conditionally forwards the information 266 to the site map Java applet 265 (using JavaScript to Java communication). The site map 265 does not directly annotate its map when a link is clicked on within its graphical area. Instead it communicates the link click event 260 to the tracker 112, which in turn communicates 266 the link click event 260 back to the site map 265 after it has processed the information for the link. So whether the link click came from the site map, or either the “main” or “menu” frames of the browser, it will enter the site map 265 for processing from the same source (the tracker 112). The links that target the “main” frame within a course are special “JavaScript” links. These links basically perform identically to the HTML links, but must be communicated to the JavaScript so that they may be communicated to the tracker 112. As an example, the link for a page to “main” would generally be:

<A HREF=“0101_{—}0202.htm”TARGET=“main”>A link</A>

The equivalent JavaScript link used by the tracker is:

<A HREF=“javascript:top.track.openDoc(self, ‘0101_{—}0202.htm’, ‘main’);”>A link</A>

The “openDoc” JavaScript function call here will in turn communicate the unresolved URL and calling frame name to the tracker Java applet. This is the function that is called in links within the “menu” and “main” frames, as well as the call from the site map applet click following the Java to JavaScript communication. The tracker must resolve the URL passed to it from the “openDoc” function (determine the absolute URL relative to the course).

When the user wishes to add a note to a page's graphical representation, they <CNTL> click the page node. A dialog box comes up to allow input of a note. The user types in a note that will be associated with this page. The note will then become available and viewable in this and all subsequent sessions that the user has with the course.

The tracker also provides certain user specific information to the course. This includes the user type, full name, and email address of the “Instructor Group” they belong to. There is also custom navigation data available to scripts executing on the client. This includes data used to annotate various navigation elements in the browser's view of the “menu” frame. One of the navigation elements is the ability of the user to check off sections of the course that they have completed. This in contrast to the means the tracker utilizes to annotate the “visitation” status of a page in that the user is directly controlling the state of the annotations. So although a user may “visit” a page within a course, they may feel that they have not fully completed reading it or completed activities on it. Using the “user custom” data feature of the tracker, they will dictate when they have completed a page, and can mark it as such.

The tracker and site map applets maintain a special variable that is a descriptor for the type of user that is currently logged on. The primary user types are “Student” and “Teacher.” When the user has been determined to be a teacher, special menu items appear on and within the primary menu area associated with the site map window. Of special interest is the “Special→Student Map” menu item. Through it, each student will have their site map annotations viewable by the current teacher user, if they are a member of the current teacher user's “Instructor Group.” If they are a member of the current teacher user's instructor group, their user, first and last names will be included in a selection list that the teacher uses to select each of his or her students site map annotations.

When the “Special→Student Map” or “Special→Student Grade Report” menu items are clicked, a dialog containing the selection list described previously is presented to the teacher user. This is the user interface that the teacher uses to select some information for one of their students. When viewing the student's site map or grade report, it may be desirable for the teacher to peruse the course for reference information. When the student selection dialog for student site map or student grade reports is closed, the tracker automatically puts the teacher back to the location where he or she was at the time just before they made the menu selection to view a student site map or grade report.

Additional features of the present invention include zooming capabilities on the site map to change the size of the text and to expand or collapse the site map to display more or fewer linked pages in a course. A teacher may also be able to access a composite view of the activity with a particular DL program or DL program course. The teacher can see this activity at either the section or sub-section level.

When introducing elements of the present invention of the preferred embodiments thereof, the articles “a”, “an”, “the” and “said” are intended to mean that there are one or more of the elements. The terms “comprising”, “including” and “having” are intended to be inclusive for the elements listed and that additional elements other than the listed elements may exist.

As various changes could be made in the above constructions without departing from the scope of the invention, it is intended that all matter contained in the above description or shown in the accompanying drawings shall be interpreted as illustrative and not in a limiting sense.

What is claimed is:

1. A teaching system for use by a user with a user processor for teaching the user information, said system comprising:
a distance learning program having a URL structure of linked pages accessible by the user via the user processor wherein the linked pages include the information to be taught to the user; and
a tracker software program tracking the user's progress through the linked pages of the distance learning program and creating a history file of pages visited by the user, said history file remotely stored on a server for independent access by the user via the user processor and by a teacher via a teacher processor.

2. The teaching system of claim 1 wherein the distance learning program further comprises a site map for graphically displaying the URL structure of linked pages to the user via the user processor, and wherein the site map displays to the user via the user processor and/or teacher via the teacher processor the user's progress based on the history file.

3. The teaching system of claim 2 wherein the site map is generated by a web crawler program.

4. The teaching system of claim 2 wherein the site map is color coded to indicate the pages previously visited by the user, the page currently being visited by the user, and/or the pages not previously visited by the user.

5. The teaching system of claim 2 wherein the site map allows the user to return to the last page of the distance learning program visited by the user during a previous session.

6. The teaching system of claim 2 wherein the site map comprises a tree view of the URL structure of the distance learning program.

7. The teaching system of claim 2 wherein the site map comprises a outline view of the URL structure of the distance learning program.

8. The teaching system of claim 2 further comprising a note created by the user and attached to any object page of the site map selected by the user, said note displayed to the user and/or teacher on the site map.

9. The teaching system of claim 1 wherein the tracker software program is stored on the user processor.

10. The teaching system of claim 1 wherein the URL structure of linked pages is targeted to a beginning page of the distance learning program.

11. The teaching system of claim 1 wherein the distance learning program comprises at least one course having a URL structure of linked pages and a course beginning page, and wherein the URL structure of linked pages for each course is targeted to the course beginning page for the respective course.

12. The teaching system of claim 11 wherein each course further comprises a unit level of pages and at least a section level of pages and wherein the course beginning page is URL linked to the respective course unit level of pages and the unit level pages are in turn URL linked to the respective course section level of pages.

13. The teaching system of claim 1 wherein the URL structure of linked pages comprises a URL for each linked page and wherein the tracker software program stores the URL for each linked page visited by the user in the history file.

14. The teaching system of claim 1 wherein the distance learning program has a file system directory structure and wherein the URL structure of linked pages is independent of the file system directory structure.

15. The teaching system of claim 1 wherein the tracker software program comprises a Java applet.

16. A method for tracking and displaying a user's progress through a distance learning program having a URL structure of linked pages accessible by a user with a user processor, said pages including information to be taught to the user, and a site map for graphically displaying the URL structure of linked pages to the user via the user processor, said method comprising:
tracking the user's progress through the linked pages of the distance learning program;
creating a history file of pages visited by the user, said history file remotely stored on a server for independent access by the user via the user processor and a teacher via a teacher processor;
receiving a request from the user for a site map of the distance learning program; and
displaying the user's progress based on the history file to the user via the site map, said site map displayed to the user via the user processor.

17. The method of claim 16 further comprising:
receiving a request from the teacher for a site map of the distance learning program; and
displaying the user's progress based on the history file to the teacher via the site map, said site map displayed to the teacher via the teacher processor.
